(19) United States
(12) Patent Application Publication
(10) Pub. No.: US 2012/0154719 A1
(43) Pub. Date: Jun. 21, 2012

(54) LIGHT DIFFUSION POLARIZING SHEET, METHOD FOR PRODUCING LIGHT DIFFUSION POLARIZING SHEET, AND DISPLAY DEVICE

(75) Inventor: Tokiyoshi Umeda, Osaka-shi (JP)

(73) Assignee: SHARP KABUSHIKI KAISHA, Osaka-shi, Osaka (JP)

(21) Appl. No.: 13/391,922

(22) PCT Filed: Nov. 19, 2010
(86) PCT No.: PCT/JP2010/070710

§ 371 Date: Feb. 23, 2012

(30) Foreign Application Priority Data
Nov. 25, 2009 (JP) 2009-267856

(51) Int. Cl. G02F 1/1335; B32B 37/12; B32B 37/16; G02B 5/30

(52) U.S. Cl. 349/96; 359/493.01; 156/60; 156/306.6

(57) ABSTRACT

In order to provide a light diffusion polarizing sheet which reduces generation of an image blur and is easily manufactured, a light diffusion polarizing sheet (1) according to the present invention includes a polarizer (2) and a light diffusion layer (3). The polarizer (2) includes a polarizing layer (4) and a first protective layer (6) to which the polarizing layer (4) is attached via an adhering layer (5). In the polarizer (2), the light diffusion layer (3) is provided on a surface of the polarizing layer (4), on which surface the first protective layer (6) is not provided. This reduces a distance from a liquid crystal cell (8) to the light diffusion layer (3), and therefore reduces the number of members and the number of process.

### REFERENCE TO RELATED APPLICATIONS

This application is the national stage under 35 USC 371 of International Application No. PCT/JP2010/070710, filed Nov. 19, 2010, which claims priority from Japanese Patent Application No. 2009-267856, filed Nov. 25, 2009, the entire contents of which are incorporated herein by reference.

### FIELD OF THE INVENTION

The present invention relates to a light diffusion polarizing sheet, and a method for manufacturing the light diffusion polarizing sheet, and a display device including the light diffusion polarizing sheet.

### BACKGROUND OF THE INVENTION

A polarizing plate, which is used in a liquid crystal display device, has an arrangement in which a polarizing layer is inserted between two protective layers. Patent Literature 1 discloses a polarizing plate integrated with a phase difference film. The polarizing plate includes two TAC films used as the protective layers, and the two TAC films are attached to both surfaces of the polarizing layer via adhering layers, respectively. Patent Literature 2 also discloses a polarizing plate similar to that disclosed in Patent Literature 1.

Conventionally, in order to improve a liquid crystal display device in visibility to observers by increasing a viewing angle, a light diffusion sheet is used. The light diffusion sheet is a sheet to be attached to a polarizing plate of the liquid crystal display device, and is configured to achieve a free viewing angle (no restrictions on viewing angle) in the liquid crystal display device by refracting light, which is emitted from the liquid crystal display device, in multiple directions on the basis of a refractive index difference. As such light diffusion sheet, Patent Literature 3 discloses a light diffusion sheet for preventing reduction in contrast of an image by the following manner: (i) diffusing light in a groove having a v-like cross-sectional shape, which groove is provided in a light diffusion layer, and (ii) absorbing stray light with use of a light absorbing layer provided so as to cover the groove. Similar light diffusion sheets are disclosed in Patent Literatures 3 to 7.

### CITATION LIST

Patent Literature 1
Japanese Patent Application Publication Tokukai No. 2006-133328 A (Publication Date: May 25, 2006)

Patent Literature 2
Japanese Patent Application Publication Tokukai No. 2006-241306 A (Publication Date: Sep. 14, 2006)

Patent Literature 3
Japanese Patent Application Publication Tokukai No. 2000-352608 A (Publication Date: Dec. 19, 2000)

Patent Literature 4
Japanese Patent Application Publication Tokukai No. 2004-4148 A (Publication Date: Jan. 8, 2004)

Patent Literature 5
Japanese Patent Application Publication Tokukai No. 2007-517929 A (Publication Date: Jul. 5, 2007)

Patent Literature 6
Japanese Patent Application Publication Tokukai No. 2008-90324 A (Publication Date: Apr. 17, 2008)

Patent Literature 7
Japanese Patent Application Publication Tokukai No. 2008-102547 A (Publication Date: May 1, 2008)

### SUMMARY OF INVENTION

When a light diffusion sheet is used for a liquid crystal display device, the light diffusion sheet is conventionally attached via an adhering layer to a polarizing plate provided in the liquid crystal display device. In this case, however, a distance between a liquid crystal cell and the light diffusion sheet is long, so that this distance causes an image blur such as an oblique double image, thereby resulting in reduction in the visibility. Further, the polarizing plate and the light diffusion sheet are each constituted by a plurality of films, so that manufacturing steps of the polarizing plate and the light diffusion sheet become complicate. This causes low throughput and yield.

The present invention has been made in view of the aforementioned problem, and an object of the present invention is to provide: a light diffusion polarizing sheet which reduces generation of an image blur and can be easily manufactured; a method for manufacturing the light diffusion polarizing sheet; and a display device including the light diffusion polarizing sheet.

In order to attain the aforementioned object, a light diffusion polarizing sheet according to the present invention includes: a polarizer including a polarizing layer to which a first protective layer is attached via a first adhering layer; and a light diffusion layer provided on a surface of the polarizing layer, the surface facing away from the first protective layer, the light diffusion layer including a light diffusion section for diffusing light which enters through the polarizer and then travels in directions across a thickness of the light diffusion layer.

This arrangement can remarkably reduce a distance from a liquid crystal cell to the light diffusion section in comparison with a conventional arrangement including a polarizing plate and a light diffusion sheet. This makes it possible to prevent reduction in visibility generated by the image blur such as an oblique double image which is caused by the distance from the liquid crystal cell to the light diffusion section. In addition, the number of members and the number of process are reduced, and throughput and yield are accordingly improved. This leads to reduction in cost.

A method for manufacturing the light diffusion polarizing sheet according to the present invention includes: a light diffusion layer forming step for forming a light diffusion layer on a polarizer, wherein the polarizer includes a polarizing layer to which a first protective layer is attached via a first adhering layer, the light diffusion layer includes a light diffusion section for diffusing light which enters through the polarizer and then travels in directions across a thickness of the light diffusion layer, and the light diffusion layer forming step forms the light diffusion layer on a surface of the polarizing layer, the surface facing away from the first protective layer.

As described above, one protective layer of the polarizing layer of the polarizer, a base film, and the adhering layer via which the base film is adhered are omitted. This makes it possible to manufacture a light diffusion polarizing sheet which can remarkably reduce a distance from a liquid crystal cell to the light diffusion section in comparison with a conventional arrangement including a polarizing plate and a light diffusion sheet and prevent reduction in visibility generated by the image blur such as an oblique double image which is caused by the distance from the liquid crystal cell to the light diffusion section. In addition, the number of members and the number of process are reduced, and throughput and yield are accordingly improved. This leads to reduction in cost.

A display device according to the present invention includes a liquid crystal panel, the liquid crystal panel including (i) a light diffusion polarizing sheet according to any one of the light diffusion polarizing sheets and (ii) a liquid crystal cell layer to which the light diffusion polarizing sheet is attached.

This arrangement makes it possible to attain a liquid crystal panel which can remarkably reduce a distance from a liquid crystal cell to the light diffusion section in comparison with a conventional arrangement including a polarizing plate and a light diffusion layer and prevent reduction in visibility generated by the image blur such as an oblique double image which is caused by the distance from the liquid crystal cell to the light diffusion section. In addition, the number of members and the number of process are reduced, and throughput and yield are accordingly improved. This leads to reduction in cost.

A light diffusion polarizing sheet according to the present invention includes: a light polarizing layer to which a first protective layer is attached via a first adhering layer; a light diffusion section for diffusing light entering through the light polarizing layer; and a light diffusing layer provided on a surface of the light polarizing layer, the surface facing away from the first protective layer. Accordingly, the light diffusion polarizing sheet can reduce generation of an image blur such as an oblique double image by reducing a distance from a liquid crystal cell to a light diffusion section. In addition, since the number of members and the number of process are reduced, the light diffusion polarizing sheet can be easily manufactured.

### BRIEF DESCRIPTION OF DRAWINGS

FIG. 1 is a cross-sectional view illustrating an embodiment of a light diffusion polarizing sheet according to the present invention.

FIGS. 2(a) and 2(b) are schematic views each illustrating a light path of light from a liquid crystal cell.

FIG. 3 is a cross-sectional view illustrating another embodiment of a light diffusion polarizing sheet according to the present invention.

FIG. 4 is a cross-sectional view illustrating still another embodiment of a light diffusion polarizing sheet according to the present invention.

FIG. 5 is a cross-sectional view illustrating yet another embodiment of a light diffusion polarizing sheet according to the present invention.

FIG. 6 is a cross-sectional view illustrating still yet another embodiment of a light diffusion polarizing sheet according to the present invention.

### DETAILED DESCRIPTION OF THE INVENTION

### Embodiment 1

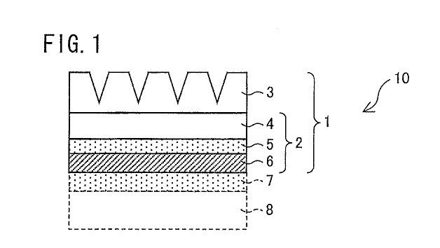

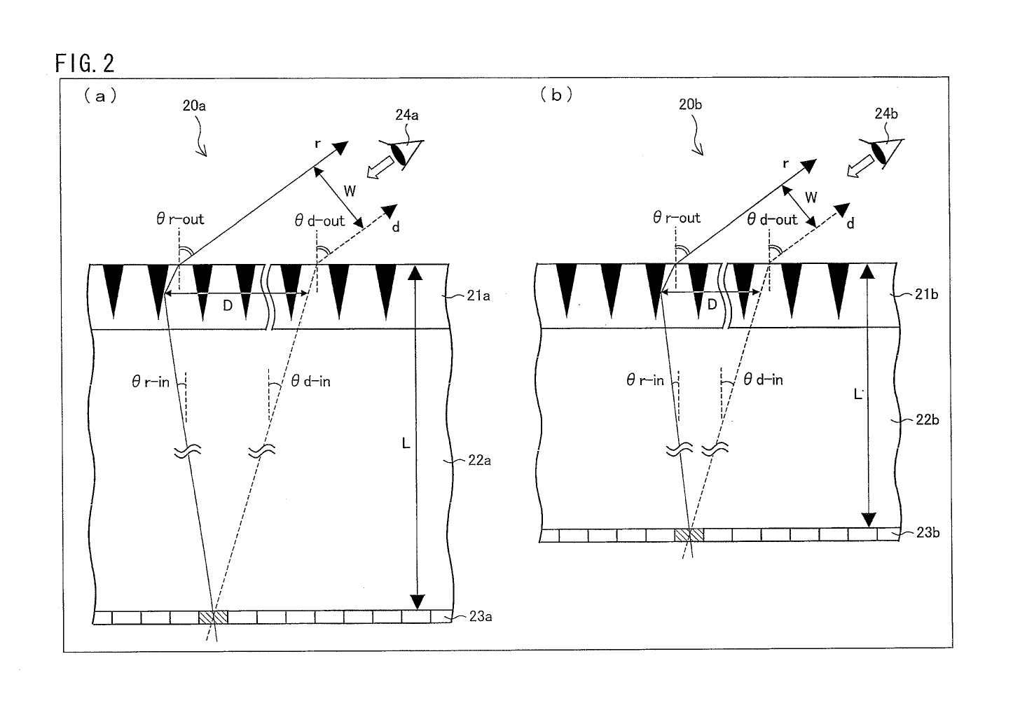

An embodiment of a light diffusion polarizing sheet 1 according to the present invention will be described below with reference to FIG. 1 and FIGS. 2(a) and 2(b). FIG. 1 is a cross-sectional view illustrating the light diffusion polarizing sheet 1 according to an embodiment of the present invention. FIGS. 2(a) and 2(b) are schematic views each illustrating a light path of light from a liquid crystal cell. As illustrated in FIG. 1, the light diffusion polarizing sheet 1 includes a polarizer 2 and a light diffusion layer 3. The polarizer 2 includes a polarizing layer 4 and a first protective layer 6 attached to the polarizing layer 4 via an adhering layer (first adhering layer) 5. In the polarizer 2, the light diffusion layer 3 is provided directly on a surface of the polarizing layer 4, the surface facing away from the first protective layer 6 (i.e., on a surface of the polarizing layer 4, on which surface the first protective layer 6 is not provided). Further, in the polarizer 2, a surface of the first protective layer 6, the surface facing away from the polarizing layer 4 (i.e., a surface on which the polarizing layer 4 is not provided) is attached to a liquid crystal cell (liquid crystal cell layer) 8 via an adhering layer 7. In this way, a liquid crystal panel 10 is formed. Note that each layer constituting the light diffusion polarizing sheet 1 and the liquid crystal panel 10 are optically transmissive.

The polarizer 2 is formed such that the first protective layer 6 is attached to the polarizing layer 4 via the adhering layer 5. The polarizing layer 4 controls passage of light emitted from a display device by polarizing the light as to a vibration direction of the light, and may be made from a conventionally known polarization material. The polarizing layer 4 can be made from any one of an organic polarization material and an inorganic polarization material. The organic polarization material is, for example, polyvinyl alcohol (PVA) adsorbing a bichromophoric molecule such as a high order iodine ion. Such polarizing layer is disclosed in each Patent Literature of a cited document 1 (Heisei 16 year Patent Distribution Support Chart (Chemistry 26) Polarizing Plate Resin for Liquid Crystal, National Center For Industrial Property Information And Training) which is incorporated herein as reference.

The first protective layer 6 is not particularly limited as long as the first protective layer 6 can protect the polarizing layer 4, and a known protective layer can be used, for example, triacetylcellulose (TAC), cyclic olefin polymer (COP), or polycarbonate (PC) can be suitably used. The first protective layer 6 preferably has a thickness of 30 μm to 100 μm, and more preferably has 30 μm to 50 μm in order to reduce its thickness. As the adhering layer 5 for adhering the polarizing layer 4 and the first protective layer 6 to each other, a conventionally known adhesive can be suitably used.

The polarizer 2 may be manufactured by means of a conventionally known method. In a case where the polarizing layer 4 is made from the PVA adsorbing iodine, the polarizer 2 can be manufactured such that (for example, see Patent Literature 2): a stretched polyvinyl alcohol film is caused to adsorb iodine, to thereby be formed into the polarizing layer 4; and then the first protective layer 6 is attached to the polarizing layer 4 via the adhering layer 5.

The light diffusion layer 3 is constituted by a light diffusion section for diffusing light entering through the polarizer 2. That is, in the present embodiment, the light diffusion layer 3 is a light diffusion section. In order to increase a viewing angle of the display device, the light diffusion layer 3 receives light from a polarizer 2 side, and refracts and diffuses light traveling in directions across a thickness of the light diffusion layer 3, so that the light thus diffused is emitted outside the light diffusion polarizing sheet 1. As the light diffusion layer 3, a conventionally known light diffusion layer can be used. The light diffusion layer 3 preferably has a thickness of 1 μm to 100 μm, and more preferably has 1 μm to 5 μm in order to reduce its thickness.

Examples of the light diffusion layer 3 encompass one in which a high refractive material layer made from a high refractive material has an observed surface having a plurality of recessed sections which are recessed toward the polarizing layer 4 from the observed surface (which faces away from the polarizing layer 4, i.e., a light emitting surface). The recessed sections may be arranged to have a substantially v-like cross-sectional shape which is tapered toward the polarizing layer 4 (toward a light entering surface), when the high refractive material layer is cut in its thickness direction (i.e., is cut along a plane (cross-sectional shape) extending to a surface facing to the polarizing layer from the surface of the light polarizing layer 3, the surface facing away from the polarizing layer 4). Further, a shape of the recessed sections is not particularly limited, and for example, the recessed sections may be grooves formed linearly, or conic recesses formed in a dot pattern. Furthermore, how to array the plurality of recessed sections is not particularly limited as long as the recessed sections are provided in the observed surface in one dimensional direction and two dimensional directions, and the recessed sections may be provided in substantially parallel with each other, or may be provided randomly.

When using the light diffusion layer 3 thus manufactured, the recessed sections totally reflect at their interfaces or pass the light entering therein from the polarizer 2 side, whereby the light thus reflected at the interfaces of the recessed sections are emitted in outward directions. This makes it possible to attain a wide viewing angle. Note that an arrangement of the light diffusion layer 3 is not limited thereto, and the light diffusion layer 3 may be configured as described in each embodiment described below. In other words, the light diffusion layer 3 is only required that there is such a refractive index difference that the inside of the recessed sections is lower in refractive index than the light diffusion layer 3 other than the recessed sections.

As a high refractive index material for forming the light diffusion layer 3, a conventionally known material may be used as shown in Patent Literatures 3 to 7. The high refractive index material may be a material having high moisture permeability, which is used as a material from which the first protective layer 6 of the polarizer 2 is made, such as TAC, COP, or PC. This makes it possible to attain the light diffusion layer 3 which effectively dehydrates to the outside moisture generated when the polarizing layer 4 is formed, whereby the light diffusion layer 3 can function to diffuse light while serving as a protective layer of the polarizing layer 4.

Further, if an amorphous thermoplastic resin (light transmittance is 85% or more and a coefficient of water absorption is in the range from 0.5% to 5.0%) described in Patent Literature 1 is used as the high refractive index material, the light diffusion polarizing sheet 1 can be such that the light diffusion layer 3 not only keep the function as a light diffusion layer while sufficiently protecting the polarizing layer 4, but also is reduced in generation of curling and cracking.

For example, the light diffusion polarizing sheet 1 can be manufactured as follows: the polarizer 2 is formed by attaching the first protective layer 6 to the polarizing layer 4 via the adhering layer 5; a high refractive material layer is formed on a surface of the polarizer 2, the surface facing away from the first protective layer 6 (i.e., on a surface of the polarizer 2, on which surface the first protective layer 6 is not attached); and the light diffusion layer 3 is formed such that recessed sections each having a v-like cross-sectional shape are formed in the high refractive material layer (light diffusion layer forming step).

As described above, the light diffusion polarizing sheet 1 is a sheet in which the polarizer 2 and the light diffusion layer 3 are integrated with each other by forming the light diffusion layer 3 directly on the polarizing layer 4 (serving as a base) of the polarizer 2. Accordingly, unlike a conventional polarizing plate, the present invention does not need to provide protective layers on both surfaces of a polarizing layer, and the light diffusion layer 3 functions as one of the protective layers. Further, the present invention does not need to have a base film that is conventionally necessary as a support for the formation of the light diffusion sheet. In the present invention, the polarizer 2 functions as the support.

According to the light diffusion polarizing sheet 1, one protective layer of the polarizing layer of the polarizer 4, a base film, and the adhering layer via which the base film is adhered are omitted. Therefore, a distance from a liquid crystal cell 8 to the light diffusion section is remarkably reduced in comparison with a conventional arrangement including a polarizing plate and a light diffusion sheet. This makes it possible to prevent reduction in visibility generated by the image blur such as an oblique double image which is caused by the distance from the liquid crystal cell 8 to the light diffusion section.

Hereinafter, an oblique double image caused by a distance from a liquid crystal cell 8 to the light diffusion section will be described with reference to FIGS. 2(a) and 2(b). In a liquid crystal panel 20a illustrated in FIG. 2(a), a distance L from a pixel of a liquid crystal display 23a to a surface of a light diffusion layer 21a is long because the base film 22a of the light diffusion layer and the polarizer are thick. Meanwhile, in a liquid crystal panel 20b illustrated in FIG. 2(b), a distance L from a pixel of a liquid crystal display 23b to a surface of a light diffusion layer 21b is short because a base film 22b of the light diffusion layer and the polarizer are thinner.

In FIGS. 2(a) and 2(b), an oblique-viewing double image width W viewed at viewing sections 24a and 24b are in proportion with distances L and L, respectively. That is, an image blur of a double image is recognized more clearly as the width W is large. Light, which has been emitted from one pixel of liquid crystal displays 23a and 23b, passes through a light path r, and reaches the light diffusion layers 21a and 21b, respectively. Then the light is totally reflected on and outputted from the recessed sections each having a v-like cross-sectional shape (total reflection light). Meanwhile, light, which has been emitted from the one pixel and passed a light path d, reaches the light diffusion layers 21a and 21b and is outputted without being reflected (straightly transmitting light).

In this case, light emitting angles θᵣ₋ₒᵤₜ and θ_{d-out}, which have been emitted from one pixel and then have passed through a light path r and a light path d, are constant, irrespective of a distance L. Meanwhile, a distance D between the light path r and the light path d of each of the light diffusion layers 21a and 21b, and the width W between the emitted total reflection light and the straight passing light are increased as the distance L is increased, and are decreased as the distance L is decreased. A double image blur becomes less likely to be recognized at the viewing section 24a and 24b as the W becomes short, that is, visual property is improved as the W becomes short. For example, when the W is 250 μm or less, the double image blur is hardly recognized, and when the W is 150 μm or less, the double image blur cannot be recognized.

The one protective layer (basically, from 50 μm to 80 μm), the base film (basically, 100 μm), and the adhering layer (basically, 10 μm) to which the one protective layer and the base film are adhered are omitted, so that the distance L of the light diffusion polarizing sheet 1 falls within the range from 160 μm to 190 μm, i.e., becomes shorter than a conventional light diffusion polarizing sheet including a polarizing plate and a light diffusion sheet. Accordingly, since the width W becomes short, generation of an oblique double image can be sufficiently reduced.

Further, the polarizing plate and the light diffusion sheet each have a multilayer structure and need the large number of members, and therefore require increase in the number of process. This leads to low throughput and low yield. The light diffusion polarizing sheet 1 does not include the one protective layer, the base film, and the adhering layer to which the one protective layer and the base film are adhered, and the number of members and the number of process are accordingly reduced, so that throughput and yield are improved. This leads to reduction in cost.

### Embodiment 2

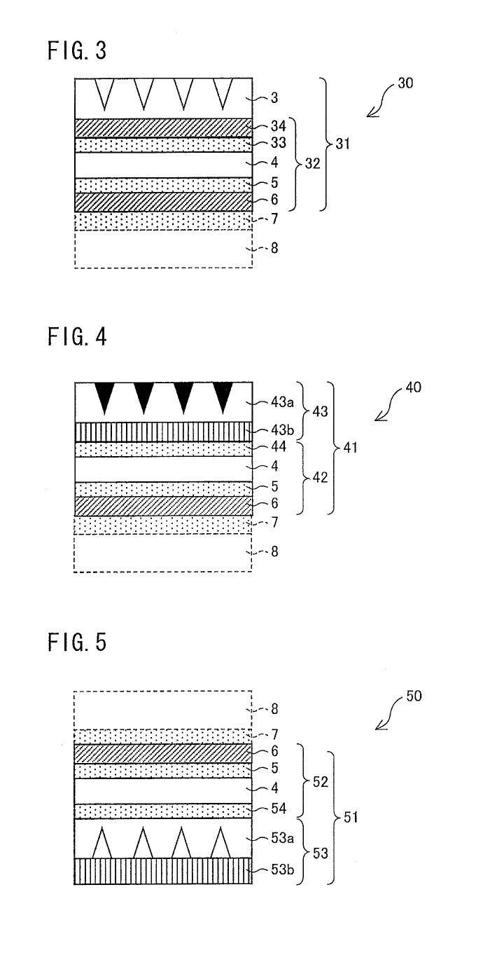

A light diffusion polarizing sheet 31 according to another embodiment of the present invention will be described below with reference to FIG. 3. FIG. 3 is a cross-sectional view illustrating the light diffusion polarizing sheet 31 according to the another embodiment of the present invention. As illustrated in FIG. 3, the light diffusion polarizing sheet 31 is different from other embodiments in that an adhering layer (second adhering layer) 33 and a second protective layer 34 are provided between a light diffusion layer 3 (serving as a light diffusion section) and a polarizing layer 4. In addition, the light diffusion polarizing sheet 31 is also different from other embodiments in that the inside of the recessed sections provided in an observed surface of the light diffusion layer 3 (i.e., in a surface of the light diffusion layer 3, the surface facing away from a polarizer 32) is filled with a light transmittance material having a refractive index which is lower than that in the light diffusion section other than the plurality of recessed sections and is higher than that in the air. In the present embodiment, a difference between the present embodiment and Embodiment 1 will be only described, and detailed description of points same as Embodiment 1 are herein omitted.

The light diffusion polarizing sheet 31 includes the polarizer 32 and the light diffusion layer 3. The polarizer 32 is a polarizer to which the second protective layer 34 is attached, via the adhering layer 33, on a surface of the polarizing layer 4 (to which the first protective layer 6 is attached via the adhering layer 5), the surface facing away from the first protective layer 6. The light diffusion layer 3 is provided on the second protective layer 34 of the polarizer 32. Moreover, in the polarizer 32, a surface of the first protective layer 6, the surface facing away from the polarizing layer 4, is attached to the liquid crystal cell 8 via the adhering layer 7. In this way, a liquid crystal panel 30 is formed.

The second protective layer 34 can be formed in the same way as the first protective layer 6, and the adhering layer 33 can be formed in the same way as the adhering layer 5. The polarizer 32 is formed such that the second protective layer 34 is formed via the adhering layer 33 on a surface of the polarizing layer 4, the surface facing away from the first protective layer 6 (second protective layer forming step). The polarizer 32 has an arrangement in which both surfaces of the polarizing layer 4 are inserted between two protective layers (first protective layer 6 and second protective layer 34), and has an arrangement similar to a conventional polarizing plate. Accordingly, a conventional polarizing plate, which is commercially available, can be used as the polarizer 32 of the light diffusion polarizing sheet 31, and the development cost can be reduced.

Unlike a conventional light diffusion polarizing sheet including a polarizing plate and a light diffusion sheet, the light diffusion polarizing sheet 31 can omit the base film, because, in the light diffusion polarizing sheet 31, the light diffusion layer 3 is formed directly on the second protective layer 34 of the polarizer 32. Accordingly, a distance from the liquid crystal cell 8 to the light diffusion section can be shorter by omitting a thickness of a base film from the distance. This makes it possible to sufficiently reduce generation of an image blur such as an oblique double image, so that the visibility is improved. Further, the light diffusion polarizing sheet 31 can be manufactured with use of fewer members at low cost.

Further, the inside of the recessed sections of the light diffusion layer 3 is filled with a light transmittance material having a refractive index which is lower than that in the light diffusion section other than the recessed sections and is higher than that in the air. Therefore, light entering the recessed sections through the polarizer 2 is totally reflected on an interface of the recessed sections depending on a refractive index difference between the inside and the outside at the recessed sections, so that the light thus totally reflected is emitted outside through the light diffusion section. This makes it possible to attain a wide viewing angle. As such light transmittance material, a conventionally known material is suitably applicable. Note that the light diffusion layer 3 according to the present embodiment may be configured as described in other embodiments.

### Embodiment 3

A light diffusion polarizing sheet 41 according to still another embodiment of the present invention will be described below with reference to FIG. 4. FIG. 4 is a cross-sectional view illustrating the light diffusion polarizing sheet 41 according to the still another embodiment of the present invention. As illustrated in FIG. 4, the light diffusion polarizing sheet 41 is different from other embodiments in that an adhering layer 43 includes a base film (base section) 43b between a light diffusion section 43a and a light polarizing layer 4 and the base film 43b is attached to the polarizing layer 4 via an adhering layer 44. In addition, the light diffusion polarizing sheet 41 is also different from other embodiments in that the inside of the recessed sections provided in an observed surface of a light diffusion section 43a of the light diffusion layer 43 (i.e., in a surface of light diffusion section 43a, the surface facing away from a polarizer 32) is filled with a light-shielding material having a refractive index which is lower than that in the light diffusion section other than the recessed sections and is higher than that in the air. In the present embodiment, a difference between the present embodiment and other embodiments will be only described, and detailed description of points same as the other embodiments are herein omitted.

The light diffusion polarizing sheet 41 includes the polarizer 42 and the light diffusion layer 43. The polarizer 42 includes the adhering layer 44 which is attached on a surface of the polarizing layer 4 (to which the first protective layer 6 is attached via the adhering layer 5), the surface facing away from the first protective layer 6. The light diffusion layer 43 includes the light diffusion section 43a and the base film 43b, and the base film 43b is attached to the polarizer 42 via the adhering layer 44. Moreover, in the polarizer 42a, a surface of the first protective layer 6, the surface facing away from the polarizing layer 4, is attached to the liquid crystal cell 8 via the adhering layer 7. In this way, a liquid crystal panel 40 is formed.

As the base film 43b, a conventionally known base film such as base films shown in Patent Literatures 3 to 7 may be used. The base film 43b supports the light diffusion section 43a. The adhering layer 44 may be arranged in the same way as the adhering layer 5. The light diffusion section 43a provides recessed sections by forming the high refractive material layer on the base film 43b, and is formed such that the inside of the recessed sections of the light diffusion layer 3 is filled with a light-shielding material having a refractive index which is lower than that in the light diffusion section other than the recessed sections and is higher than that in the air. In this way, in the light diffusion polarizing sheet 41, the light diffusion section 43a and the base film 43b.

A method for manufacturing the light diffusion polarizing sheet 41 is not particularly limited. For example, the polarizer 42 is formed by attaching one surface of the polarizing layer 4 to the first protective layer 6 via the adhering layer 5, and then by providing the adhering layer 44 on a surface of the polarizing layer 4, the surface facing away from the first protective layer. Then, the base film 43b of the light diffusion layer 43 formed in the aforementioned way is attached to the adhering layer 44 of the polarizer 42. In this way, the light diffusion polarizing sheet 41 is manufactured.

When the light diffusion layer 43 including the light diffusion section 43a and the base film 43b is attached to the polarizing layer 4 via the adhering layer 44 as described above, the light diffusion layer 43 functions as a protective layer of the polarizing layer 4. Accordingly, the light diffusion polarizing sheet 41 can be thinner as much as a thickness of the protective layer thus omitted. This makes it possible to sufficiently reduce generation of an oblique double image. In addition, the number of members and the number of process can be reduced, and throughput and yield are accordingly improved. This leads to reduction in cost. Further, the light diffusion layer 43 is formed by forming the light diffusion section 43a on the base film 43b, and then the light diffusion layer 43 is attached to the polarizer 42. In this way, the light diffusion layer 43 can be easily manufactured.

Further, the inside of the recessed sections of the light diffusion section 43a of the light diffusion layer 43 is filled with a light-shielding material having a refractive index which is lower than that in the light diffusion section other than the recessed sections and is higher than that in the air. Therefore, light entering the recessed sections through the polarizer 42 is totally reflected on or transmitted through an interface of the recessed sections depending on a refractive index difference between the inside and the outside at the recessed sections. Then, the light thus totally reflected is transmitted through the light diffusion section to thereby be emitted outside, and the light thus transmitted is absorbed in the light-shielding material. This makes it possible to reduce generation of stray light while attaining a wide viewing angle. As such light-shielding material, a conventionally known material is suitably applicable. Note that the light diffusion layer 43 according to the present embodiment may be configured as described in other embodiments.

### Embodiment 4

A light diffusion polarizing sheet 51 according to yet another embodiment of the present invention will be described below with reference to FIG. 5. FIG. 5 is a cross-sectional view illustrating the light diffusion polarizing sheet 51 according to the yet another embodiment of the present invention. As illustrated in FIG. 5, the light diffusion polarizing sheet 51 is different from other embodiments in that (i) an adhering layer 53 includes a base film 53b on a surface of a light diffusion section 53a, the surface facing away from a light polarizing layer 4, and (ii) the light diffusion section 53a is attached to the polarizing layer 4 via an adhering layer 54. In addition, the light diffusion polarizing sheet 51 is also different from other embodiments in that the inside of the recessed sections provided in an observed surface of a light diffusion section 53a of the light diffusion layer 53 (i.e., in a surface faces away from a polarizer 52) is filled with gas. In the present embodiment, a difference between the present embodiment and other embodiments will be only described, and detailed description of points same as the other embodiments are herein omitted. Note that FIG. 5 is different from FIGS. 1, 3, and 4 in that a liquid crystal cell 8 of a liquid crystal panel 50 is positioned on an upper part of FIG. 5. However, merely a direction of FIG. 5 is different from directions of other liquid crystal panels illustrated in FIGS. 1, 3, and 4, and functions, purposes, use, etc. of the liquid crystal panel 50 are same as the other liquid crystal panels. The light diffusion polarizing sheet 51 includes the polarizer 52 and the light diffusion layer 53. The polarizer 52 is a polarizer in which the second protective layer 54 is attached on a surface of the polarizing layer 4 (to which a first protective layer 6 is attached via an adhering layer 5), the surface facing away from the first protective layer 6. The light diffusion layer 53 includes the light diffusion section 53a and the base film 53b, and the light diffusion section 53a is attached to the polarizer 52 via the adhering layer 54. Moreover, a surface of the first protective layer 6 of the polarizer 52, the surface facing away from the polarizing layer 4, is attached to the liquid crystal cell 8 via the adhering layer 7. In this way, a liquid crystal panel 50 is formed.

The light diffusion layer 53a is formed to have recessed sections recessed toward the polarizing layer 4 from an observed surface of a high refractive material layer made from a high refractive index material (a surface of the light diffusion layer 53a, the surface facing away from the polarizing layer 4, i.e., light emitting surface). Then, the base film 53b is attached to the light diffusion layer 53a so as to cover the recessed sections. In this way, the light diffusion layer 53 is formed. When the base film 53b is attached to the light diffusion layer 53a, the recessed sections need to be filled with gas such as the air.

A method for manufacturing the light diffusion polarizing sheet 51 is not particularly limited. For example, the polarizer 52 is formed by attaching one surface of the polarizing layer 4 to the first protective layer 6 via the adhering layer 5, and then providing the adhering layer 54 on a surface of the polarizing layer 4, the surface facing away from the first protective layer. Then, the light diffusion section 53a of the light diffusion layer 53 formed in the aforementioned way is attached to the adhering layer 54 of the polarizer 52. In this way, the light diffusion polarizing sheet 51 is manufactured.

The light diffusion layer 53 including the light diffusion section 53a and the base film 53b is attached to the polarizing layer 4 via the adhering layer 54 as described above, so that the light diffusion layer 53 functions as a protective layer of the polarizing layer 4. Accordingly, the light diffusion polarizing sheet can be thinner as much as a thickness of the protective layer thus omitted. Further, the base film 53b is positioned on a topmost surface of a display surface, which is the farthest film from the liquid crystal cell 8, and is not provided between the light diffusion section 53a and the liquid crystal cell 8. Accordingly, a distance from the liquid crystal cell 8 to the light diffusion section 53a can be shorter by omitting the thickness of the base film from the distance. This makes it possible to sufficiently reduce generation of an oblique double image. In addition, the number of members and the number of process can be reduced, and throughput and yield are accordingly improved. This leads to reduction in cost.

The inside of the recessed sections of the light diffusion section 53a of the light diffusion layer 53 is filled with the gas. Therefore light entering the recessed sections through the polarizer 2 is totally reflected on an interface of the recessed sections depending on a refractive index difference between the inside of the recessed sections and the outside thereof, and is then emitted outside through the light diffusion section 53a. The refractive index difference is larger than that in a case where in the inside of the recessed sections is filled with the refractive index material such as a resin. Accordingly, a wide viewing angle can be attained. Gas filling the inside of the recessed sections is not particularly limited as long as the gas reduces a refractive index of the inside more than that of the outside at the recessed sections. Note that the light diffusion layer 53 according to the present embodiment can be formed may be configured as described in other embodiments.

### Embodiment 5

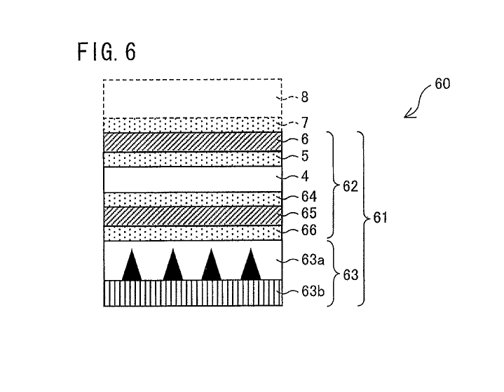

A light diffusion polarizing sheet 61 according to still yet another embodiment of the present invention will be described below with reference to FIG. 6. FIG. 6 is a cross-sectional view illustrating the light diffusion polarizing sheet 61 according to the still yet another embodiment of the present invention. As illustrated in FIG. 6, the light diffusion polarizing sheet 61 is different from other embodiments in that: (i) an adhering layer 63 includes a base film 63b on a surface of a light diffusion section 63a, the surface facing away from a light polarizing layer 4; and (ii) in a light polarizer 62, a second protective layer 65 is provided between the light diffusion section 63a and the polarizing layer 4 via an adhering layer 64, and the light diffusion section 63a is attached to the adhering layer 66 provided on the second protective layer 65. In the present embodiment, a difference between the present embodiment and other embodiments will be only described, and detailed description of points same as the other embodiments are herein omitted. Note that FIG. 6 is different from FIGS. 1, 3, and 4 in that a liquid crystal cell 8 of a liquid crystal panel 60 is positioned on an upper part of FIG. 6. However, merely a direction of FIG. 6 is different from directions of other liquid crystal panels illustrated in FIGS. 1, 3, and 4, and functions, purposes, use, etc. of the liquid crystal panel 60 are same as the other liquid crystal panels.

The light diffusion polarizing sheet 61 includes the polarizer 62 and the light diffusion layer 63. The polarizer 62 is a polarizer in which the second protective layer 65 is attached, via the adhering layer 64, to a surface of the polarizing layer 4 (to which a first protective layer 6 is attached via an adhering layer 5), the surface facing away from the first protective layer 6 and the adhering layer 66 is provided on the second protective layer 65. The light diffusion layer 63 includes the light diffusion section 63a and the base film 63b, and the light diffusion section 63a is attached to the polarizer 62 via an adhering layer 66. Moreover, a surface of the first protective layer 6 of the polarizer 62, the surface facing away from the polarizing layer 4, is attached to the liquid crystal cell 8 via the adhering layer 7. In this way, a liquid crystal panel 60 is formed.

The light diffusion polarizing sheet 61 may be formed such that the polarizer 62 is formed in the same way as the polarizer 32 illustrated in FIG. 3, and the adhering layer 66 is then provided. The light diffusion layer 63 is formed such that, for example, a protrusion section having a substantially v-like cross-sectional shape, which is tapered toward the polarizing layer 4, is formed, with use of a low refractive index material having a light-shielding effect, on the base film 63b so as to cover the protrusion section. Then, the light diffusion section 63a and the base film 63b constitute the light diffusion layer 63. The light diffusion section 63a of the light diffusion layer 63 is attached to the adhering layer 66 of the polarizer 62 formed as described above. In this way, the light diffusion polarizing sheet 61 can be manufactured. Note that the light diffusion layer 63 according to the present embodiment may be may be configured as described in other embodiments.

The base film 63b of the light diffusion polarizing sheet 61 is positioned on a topmost surface of a display surface, which is the farthest film from the liquid crystal cell 8, and is not provided between the light diffusion section 53a and the liquid crystal cell 8 as described above. Accordingly, a distance from the liquid crystal cell 8 to the light diffusion section 63a can be shorter by omitting the thickness of the base film from the distance. This makes it possible to sufficiently reduce generation of an oblique double image. Further, a commercially available conventional polarizing plate on which the adhering layer 66 is formed can be used, and the development cost can be reduced.

The present invention is not limited to the description of the embodiments above, and may be modified in numerous ways by a skilled person as long as such modification falls within the scope of the claims. An embodiment based on a proper combination of technical means disclosed in different embodiments is encompassed in the technical scope of the present invention.

It is preferable that, in the light diffusion polarizing sheet according to the present invention, the light diffusion layer is formed directly on the polarizing layer. According to the aforementioned arrangement, the light diffusion layer is formed directly on the polarizing layer including the polarizing layer as a base, the polarizing layer and the light diffusion layer are integrally formed. Accordingly, unlike a conventional light diffusion sheet, the present invention does not need to provide the protective layers on both surfaces of the polarizing layer, and the light diffusion layer functions as one protective layer. Further, the present invention does not need to have a base film that is conventionally necessary as a support for the formation of the light diffusion layer. In the present invention, the polarizing layer functions as the support.

When the one protective layer of the polarizing layer, the base film, and the adhering layer to which the base film is adhered are omitted, a distance from the liquid crystal cell to the light diffusion section is much reduced than that of a conventional arrangement including the polarizing plate and the light diffusion layer. This makes it possible to prevent reduction in visibility generated by an image blur, such as an oblique double image, which reduction in visibility is caused by the distance from the liquid crystal cell to the light diffusion section. In addition, the number of members and the number of process are reduced, and throughput and yield are accordingly improved. This leads to reduction in cost.

Further, it is preferable that, in the light diffusion polarizing sheet according to the present invention, the polarizer includes, between the polarizing layer and the light diffusion layer, a second protective layer attached to the polarizing layer via the second adhering layer.

According to the aforementioned arrangement, the base film can be omitted in a case where the light diffusion layer is formed directly on the second protective layer provided on the polarizing layer of the polarizer in comparison with a case where a conventional arrangement including the polarizing plate and the light diffusion sheet is used. Accordingly, the distance from the liquid crystal cell to the light diffusion section can be shorter by omitting the thickness of the base film from the distance. This makes it possible to sufficiently reduce generation of the image blur such as an oblique double image, so that the visibility is improved. Further, the light diffusion polarizing sheet can be manufactured with use of fewer members at low cost. Furthermore, a commercially available conventional polarizing plate, in which the protective layer are provided on both the polarizing layers, may be used as the polarizer, and the development cost can be reduced.

Further, it is preferable that, in the light diffusion polarizing sheet according to the present invention, the light diffusion layer includes, between the polarizing layer and the light diffusion section, the base section for supporting the light diffusion section.

According to the aforementioned arrangement, the light diffusion layer including the light diffusion section and the base section is attached to the polarizing layer, so that the light diffusion layer functions as the protective layer of the polarizing layer. Accordingly, the light diffusion polarizing sheet can be thinner as much as the omission of a thickness of the protective layer thus omitted. This makes it possible to sufficiently reduce generation of an oblique double image. In addition, the number of members and the number of process are reduced, and throughput and yield are accordingly improved. This leads to reduction in cost. Further, the light diffusion layer can be formed by forming the light diffusion section on the base section, and then attaching the light diffusion layer to the polarizing layer. This arrangement allows easy preparation of the light diffusion layer.

Further, it is preferable that, in the light diffusion polarizing sheet according to the present invention, the light diffusion layer includes: a base section on a surface of the light diffusion section, the surface facing away from the polarizing layer, the base section supporting the light diffusion section.

According to the aforementioned arrangement, the light diffusion layer including the light diffusion section and the base section is attached to the polarizing layer, the light diffusion layer functions as the protective layer of the polarizing layer. Accordingly, the light diffusion polarizing sheet can be thinner as much as a thickness of the protective layer thus omitted. Further, the base section is positioned on a topmost surface of a display surface, which is the farthest film from the liquid crystal cell, and is not provided between the light diffusion section and the liquid crystal cell. Accordingly, a distance from the liquid crystal cell to the light diffusion section can be shorter by omitting the thickness of the base film from the distance.

This arrangement makes it possible to sufficiently reduce generation of an oblique double image. In addition, the number of members and the number of process are reduced by omitting the protective layer, and throughput and yield are accordingly improved. This leads to reduction in cost. Further, the light diffusion layer can be formed by forming the light diffusion section on the base section, and then attaching the light diffusion layer to the polarizing layer. This arrangement allows easy preparation of the light diffusion layer.

Further, in the light diffusion polarizing sheet according to the present invention, the light diffusion section includes a plurality of recessed sections which are recessed toward the polarizing layer from a surface of the light diffusion section, the surface facing away from the polarizing layer. It is preferable that the light diffusion section has a cross-sectional shape having a substantially v-like shape which is tapered toward the polarizing layer in a case where the plurality of recessed sections are cut along a plane extending between (i) the surface of the light diffusion section, the surface facing away from the polarizing layer, and (ii) a surface of the light diffusion section, the surface facing the polarizing layer.

According to the aforementioned arrangement, there is the refractive index difference between the inside and the outside at the recessed sections each having a v-like cross-sectional shape provided in the light diffusion section. Therefore light entering the light diffusion section from a polarizing layer is totally reflected on an interface of the recessed sections, so that the light thus totally reflected is emitted outside through the light diffusion section. This makes it possible to attain a wide viewing angle.

Further, it is preferable that, in the light diffusion polarizing sheet according to the present invention, the inside of the plurality of recessed sections of the light diffusion layer is filled with a light transmittance material having a refractive index which is lower than that in the light diffusion section other than the plurality of recessed sections and is higher than that in the air.

According to the aforementioned arrangement, there is the refractive index difference between the inside and the outside at the recessed sections each having a v-like cross-sectional shape provided in the light diffusion section. Therefore light entering the light diffusion section from the polarizing layer is totally reflected on an interface of the recessed sections, so that the light thus totally reflected is emitted outside through the light diffusion section. This makes it possible to attain a wide viewing angle.

Further, it is preferable that, in the light diffusion polarizing sheet according to the present invention, the inside of the plurality of recessed sections of the light diffusion layer is filled with a light-shielding material having a refractive index which is lower than that in the light diffusion section other than the plurality of recessed sections and is higher than that in the air.

According to the aforementioned arrangement, there is the refractive index difference between the inside and the outside at the recessed sections each having a v-like cross-sectional shape provided in the light diffusion section. Therefore light entering the light diffusion section from a polarizing layer is totally reflected on or transmitted through an interface of the recessed sections, so that the light thus totally reflected is emitted outside through the light diffusion section, and the light thus transmitted is absorbed in the light-shielding material. This makes it possible to reduce generation of stray light while attaining a wide viewing angle.

Further, it is preferable that, in the light diffusion polarizing sheet according to the present invention, the inside of the recessed sections is filled with gas.

According to the aforementioned arrangement, there is the refractive index difference between the inside and the outside at the recessed sections each having a v-like cross-sectional shape provided in the light diffusion section, and the refractive index difference is larger than that in a case where the recessed sections are filled with a resin. Therefore light entering the light diffusion section from a polarizing layer is totally reflected on an interface of the recessed sections, so that the light thus totally reflected is emitted outside through the light diffusion section. This makes it possible to attain a wide viewing angle.

Further, it is preferable that the method for manufacturing the light diffusion polarizing sheet according to the present invention further includes: prior to the light diffusion layer forming step, a second protective layer forming step for forming a second protective layer via a second adhering layer on a surface of the polarizing layer of the polarizer, the surface facing away from a surface on which the protective layer, the light diffusion layer forming step forming the light diffusion layer on the second protective layer.

The light diffusion layer is formed directly on the second protective layer provided on the polarizing layer of the polarizer as described above. Thus, unlike a conventional arrangement including a polarizing plate and a light diffusion sheet, the light diffusion polarizing sheet of the present invention can omit the base film. Accordingly, a distance from the liquid crystal cell to the light diffusion section can be shorter by omitting a thickness of a base film from the distance. This makes it possible to manufacture a light diffusion polarizing sheet which can prevent generation of an image blur such as an oblique double image and have improved visibility. Further, the light diffusion polarizing sheet can be manufactured with a fewer members at low cost.

Further, in the method according to the present invention, it is preferable that the light diffusion layer forming step includes: forming a high refractive material layer on the polarizing layer; processing a surface of the high refractive material layer into a plurality of recessed sections recessed toward the polarizing layer, the surface facing away from the polarizing layer; and filling inside of the plurality of recessed sections with a low refractive index material.

According to the aforementioned arrangement, a high refractive material layer-including diffusion section for diffusing light entering the light diffusion layer is made from a high refractive index material, and the inside of the recessed sections formed in the high refractive material layer is filled with the low refractive index material. This makes it possible to achieve a free viewing angle (no restrictions on viewing angle) caused by the refractive index difference. Accordingly, a light diffusion polarizing sheet in which a wide viewing angle is attained can be manufactured easily and accurately.

Further, in the method according to the present invention, it is preferable that the light diffusion layer forming step includes: forming a high refractive material layer on the polarizing layer; processing a surface of the high refractive material layer into a plurality of recessed sections recessed toward the polarizing layer, the surface facing away from the polarizing layer; and covering the plurality of recessed sections with a base film in a state in which inside of the plurality of recessed sections is filled with gas. According to the aforementioned arrangement, the refractive index difference between a material for forming the light diffusion layer and the inside of the recessed sections each having the v-like cross-sectional shape is larger than that in a case where the recessed sections are filled with resin. Therefore, the light diffusion polarizing sheet, in which light entering the light diffusion section through a polarizing layer is totally reflected on a surface of the light diffusion section effectively and the light thus totally reflected is transmitted through the light diffusion section to thereby be emitted outside, can be manufactured easily and accurately.

Further, it is preferable that the method according to the present invention further includes: forming a protrusion section on a base film, the protrusion section being made from a low refractive index material; and forming a high refractive material layer on the base film so as to cover the protrusion section, wherein the light diffusion layer forming step forming the light diffusion layer by attaching the high refractive material layer to the polarizing layer.

According to the aforementioned arrangement, the protrusion section is formed on the base film with use of the low refractive index material, the high refractive material layer is formed to cover the protrusion section with a high refractive index material. In this way, the light diffusion layer is formed. This makes it possible to easily and accurately manufacture the light diffusion polarizing sheet which prevents stray light while attaining a wide viewing angle.

The present invention can be suitably used in various display devices such as a liquid crystal display device.

### REFERENCE SIGNS LIST

1 light diffusion polarizing sheet
2 polarizer
3 light diffusion layer
4 polarizing layer
5 adhering layer (first adhering layer)
6 first protective layer
7 adhering layer
8 liquid crystal cell
10 liquid crystal panel

1. A light diffusion polarizing sheet, comprising:
a polarizer including a polarizing layer to which a first protective layer is attached via a first adhering layer; and
a light diffusion layer provided on a surface of the polarizing layer, the surface facing away from the first protective layer, the light diffusion layer including a light diffusion section for diffusing light which enters through the polarizer and then travels in directions across a thickness of the light diffusion layer.

2. The light diffusion polarizing sheet as set forth in claim 1, wherein the light diffusion layer is provided directly on the polarizing layer.

3. The light diffusion polarizing sheet as set forth in claim 1, wherein the polarizer further includes, between the polarizing layer and the light diffusion layer, a second protective layer attached to the polarizing layer via a second adhering layer.

4. The light diffusion polarizing sheet as set forth in claim 1, wherein the light diffusion layer includes a base section between the polarizing layer and the light diffusion section, the base section supporting the light diffusion section.

5. The light diffusion polarizing sheet as set forth in claim 1, wherein the light diffusion layer includes a base section on a surface of the light diffusion section, the surface facing away from the polarizing layer, the base section supporting the light diffusion section.

6. The light diffusion polarizing sheet as set forth in claim 1, wherein:
the light diffusion section includes a plurality of recessed sections which are recessed toward the polarizing layer from that surface of the light diffusion section, the surface facing away from the polarizing layer; and
the light diffusion section has a cross-sectional shape having a substantially v-like shape which is tapered toward the polarizing layer in a case where the plurality of recessed sections are cut along a plane extending between (i) the surface of the light diffusion section, the surface facing away from the polarizing layer, and (ii) a surface of the light diffusion section, the surface facing the polarizing layer.

7. The light diffusion polarizing sheet as set forth in claim 6, wherein inside of the plurality of recessed sections of the light diffusion layer is filled with a light transmittance material having a refractive index which is lower than that in the light diffusion section other than the plurality of recessed sections and is higher than that in the air.

8. The light diffusion polarizing sheet as set forth in claim 6, wherein inside of the plurality of recessed sections of the light diffusion layer is filled with a light-shielding material having a refractive index which is lower than that in the light diffusion section other than the plurality of recessed sections and is higher than that in the air.

9. The light diffusion polarizing sheet as set forth in claim 6, wherein inside of the plurality of recessed sections is filled with gas.

10. A method for manufacturing the light diffusion polarizing sheet, comprising:
a light diffusion layer forming step for forming a light diffusion layer on a polarizer, wherein the polarizer includes a polarizing layer to which a first protective layer is attached via a first adhering layer, the light diffusion layer includes a light diffusion section for diffusing light which enters through the polarizer and then travels in directions across a thickness of the light diffusion layer, and the light diffusion layer forming step forms the light diffusion layer on a surface of the polarizing layer, the surface facing away from the first protective layer.

11. The method as set forth in claim 10, further comprising: prior to the light diffusion layer forming step, a second protective layer forming step for forming a second protective layer via a second adhering layer on a surface of the polarizing layer of the polarizer, the surface facing away from the first protective layer,
the light diffusion layer forming step forming the light diffusion layer on the second protective layer.

12. The method as set forth in claim 10,
wherein the light diffusion layer forming step includes:
forming a high refractive material layer on the polarizing layer;
processing a surface of the high refractive material layer into a plurality of recessed sections recessed toward the polarizing layer, the surface facing away from the polarizing layer;
and filling inside of the plurality of recessed sections with a low refractive index material.

13. The method for manufacturing the light diffusion polarizing sheet as set forth in claim 10,
wherein the light diffusion layer forming step includes:
forming a high refractive material layer on the polarizing layer;
processing a surface of the high refractive material layer into a plurality of recessed sections recessed toward the polarizing layer, the surface facing away from the polarizing layer; and covering the plurality of recessed sections with a base film in a state in which inside of the plurality of recessed sections is filled with gas.

14. The method as set forth in claim 10, further comprising:
forming a protrusion section on a base film, the protrusion section being made from a low refractive index material; and
forming a high refractive material layer on the base film so as to cover the protrusion section,
wherein the light diffusion layer forming step forming the light diffusion layer by attaching the high refractive material layer to the polarizing layer.

15. A display device, comprising:
a light diffusion polarizing sheet according to claim 1; and
a liquid crystal panel including a liquid crystal cell layer attached to the light diffusion polarizing sheet.
